(19) United States
(12) Patent Application Publication
(10) Pub. No.: US 2012/0186203 A1
(43) Pub. Date: Jul. 26, 2012

(54) FOLDED BAGHOUSE FILTER

(75) Inventor: Tian Xuan Zhang, Overland Park, KS (US)

(73) Assignee: GENERAL ELECTRIC COMPANY, Schenectady, NY (US)

(21) Appl. No.: 13/013,481

(22) Filed: Jan. 25, 2011

(51) Int. Cl. B01D 46/52; B01D 46/00

(52) U.S. Cl. 55/363; 55/380; 55/378

(57) ABSTRACT

A filter is provided and includes filter media folded into itself to have increased surface area formed of at least two filtering sections including an outer filtering section and an inner filtering section.

### BACKGROUND OF THE INVENTION

The subject matter disclosed herein relates to a folded baghouse filter.

In dust collectors for various applications, systems are often designed to use bag filters for filtering purposes. The bag filters are often disposed within a baghouse having a clean gas chamber and a dirty gas chamber separated by a tubesheet. The tubesheet has openings to which the bag filters are attached. In operation, dust-laden gas enters the dirty gas chamber and passes through the bag filters and the tubesheet openings into the clean gas chamber. As this process continues, filtration occurs whereby particulate matter, which is carried in the dust-laden gas, collects on filtering surfaces.

An amount of filtration is at least partly dependent upon the filtration area of the bag filters.

### BRIEF DESCRIPTION OF THE INVENTION

According to one aspect of the invention, a filter is provided and includes filter media folded into itself to have increased surface area formed of at least two filtering sections including an outer filtering section and an inner filtering section.

According to another aspect of the invention, a filter is provided and includes a cage and filter media supported on the cage, the filter media including an outer filtering section, a lower filtering section connected by an outer rim thereof to a first end of the outer filtering section, an inner filtering section connected by a first end thereof to an inner rim of the lower filtering section and an upper filtering section connected by a rim thereof to a second end of the inner filtering section, the second end of the inner filtering section opposing the first end thereof, and the cage supporting the upper filtering section proximate to a second end of the outer filtering section, the second end opposing the first end thereof.

According to yet another aspect of the invention, a cleaning system is provided and includes a housing, a tubesheet disposed within the housing to delimit dirty and clean chambers, the tubesheet being formed to define an opening and a filter including a cage and filter media, the cage supporting the filter media at the opening and to be folded in on itself

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic view of a cleaning system;

FIGS. 2A and 2B are axial and side views of a filter for the cleaning system of FIG. 1;

FIGS. 3A and 3B are axial and side views of a filter for the cleaning system of FIG. 1; and

FIG. 4 is a side view of filter media in accordance with embodiments;

FIG. 5 is a side view of filter media in accordance with alternative embodiments; and

FIG. 6 is a side view of filter media in accordance with further embodiments.

The detailed description explains embodiments of the invention, together with advantages and features, by way of example with reference to the drawings.

### DETAILED DESCRIPTION OF THE INVENTION

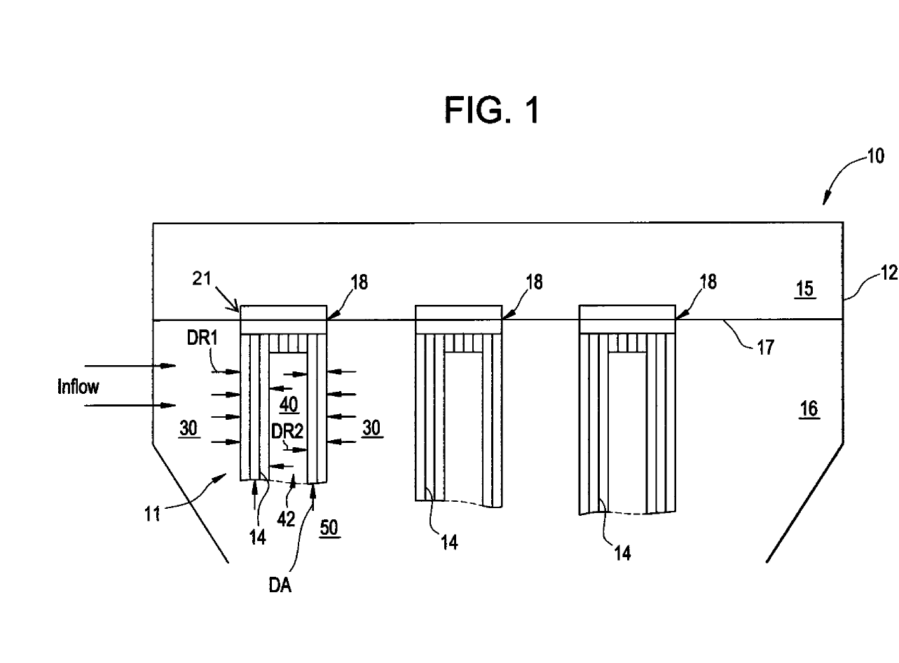

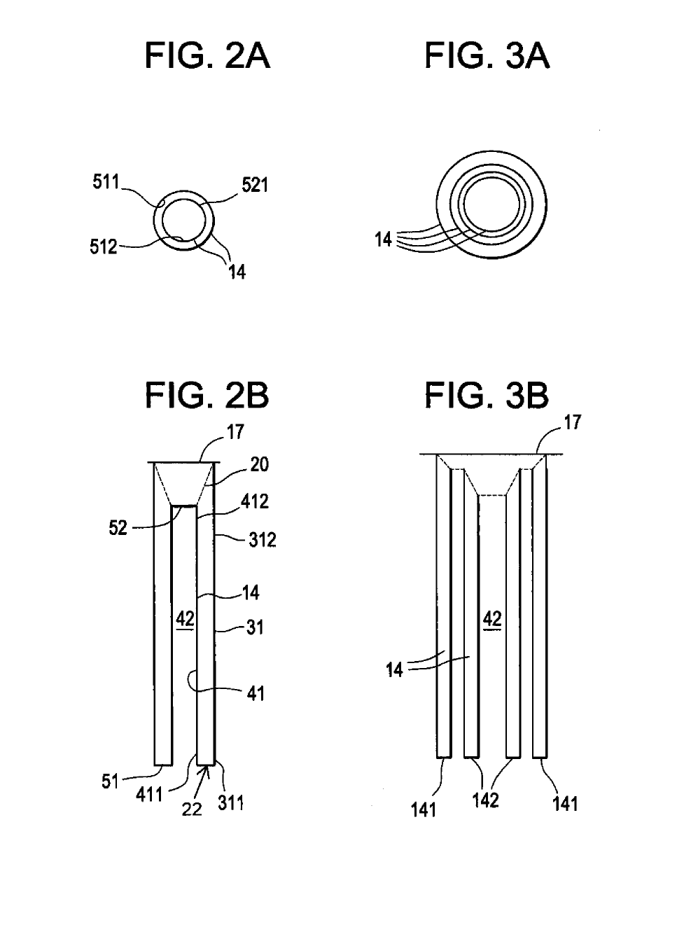

With reference to FIGS. 1, 2A and 2B, a cleaning system having baghouse 10 is provided. The baghouse 10 is designed to use a bag filter 11 for filtration. The bag filter 11 is disposed within an enclosed housing 12 and has filter media 14. The enclosed housing 12 has a clean chamber 15 and a dirty chamber 16. The clean chamber 15 and the dirty chamber 16 are separated by a tubesheet 17. The tubesheet 17 is formed to define an opening 18 at which the bag filter 11 is disposed. The opening 18 and the bag filter 11 may be arrayed through the bag house 10 in various numbers and patterns but for purposes of clarity and brevity they will be hereinafter described as respectively singular features.

In operation, inflow of gas or fluid is introduced into or otherwise enters the dirty chamber 16 and then flows into the clean chamber 15 through the bag filter 11 and the opening 18. The inflow carries with it particulate matter that collects on the filter media 14.

As shown in FIGS. 1, 2A and 2B, the bag filter 11 includes a cage 20 on which the filter media 14 is supported. The cage 20 may include a retainer 21 and a stabilizer 22. The retainer 21 connects the bag filter 11 to the tubesheet 17 or otherwise retains the bag filter 11 at the opening 18. The stabilizer 22 stabilizes the free end of the bag filter 11. The cage 20 may further include internal skeletal structures for further increasing stability and support of the filter media 14. The filter media 14 may be connected to the cage 20 in various manners. For example, the filter media 14 may be adhered to or fastened to the cage 20 at least at the respective locations of the retainer 21 and the stabilizer 22.

The support provided by the cage 20 orients the filter media 14 to be folded in on itself such that the filter media 14 filters a first portion 30 of the inflow that predominantly travels in a first inwardly oriented or radial direction, DR1, relative to the cage 20, and a second portion 40 of the inflow that predominantly travels in a second outwardly oriented or radial direction, DR2, relative to the cage 20, which opposes the first inward or radial direction, DR1. In addition, the support provided by the cage 20 may further orient the filter media 14 to filter a third portion 50 of the inflow that predominantly travels in a third or an axial direction, DA.

That is, as supported by the cage 20, the filter media 14 is folded in on itself such that the filter media 14 has an increased surface area and includes a first section 31, such as an outer inflow filtering section, to filter the first portion 30 of the inflow and a second section 41, such as an inner inflow filtering section, to filter the second portion 40 of the inflow. The filter media 14 may further include third and fourth sections 51, 52, such as lower and upper inflow filtering sections, respectively, to filter the third portion 50 of the inflow. In accordance with embodiments, the third section 51 is connected by an outer rim 511 thereof to a first end 311 of the first section 31. The second section 41 is connected by a first end 411 thereof to an inner rim 512 of the third section 51. The fourth section 52 is connected by a rim 521 thereof to a second end 412 of the second section 41, which opposes the first end 411. The cage 20 supports the fourth section 52 proximate to the tubesheet 17 and a second end 312 of the first section 31, which opposes the first end 311.

The first and second sections 31 and 41 of the filter media 14 may be substantially tubular and, in some embodiments, may be substantially cylindrical. The second section 41 may be disposed within the first section 31 and, in some embodiments, may be substantially concentric with the first section 31. In this way, the third and fourth sections 51, 52 may be substantially annular and, in some embodiments, the third section 51 may be substantially ovoid and donut-shaped with the fourth section 52 being substantially coin-shaped. Also, the third and fourth sections 51, 52 are respectively disposed at corresponding ends 311 and 411, 312 and 412 of the first and second sections 31, 41 with the third section 51 being radially interposed between the first and second sections 31, 41 and the fourth section 52 being radially disposed within the annular region 42 defined by the second section 41.

With this construction, inflow perimetrically surrounding the filter media 14 can pass through the first section 31 of the filter media 14 in the first inwardly oriented or radial direction, DR1. Inflow can also pass through the second section 41 of the filter media 14 in the second outwardly oriented or radial direction, DR2, after first traveling upwardly through the annular region 42. Additionally, inflow can pass through the third section 51 of the filter media 14 in the third or axial direction, DA, from below the bag filter 11 and through the fourth section 52 of the filter media 14 in the third or axial direction, DA, after first traveling upwardly through the annular region 42.

Thus, where the bag filter 11 as described above has a similar length as conventional bag filters, the bag filter 11 has additional filter media 14 surface area at least along the annular region 42 and, therefore, the bag filter 11 provides for additional filtering over and above conventional bag filters. This additional filtering can be increased still further, with reference to FIGS. 3A and 3B, in that the first section 31, the second section 41 and the third section 51 may each be plural in number. That is, the filter media 14 may be folded in on itself multiple times and in multiple stages 141, 142 whereby increased numbers of one or multiple folding stages corresponds to increased filtering surface area where the overall length of the bag filter 11 remains similar to conventional bag filters.

The overall shape of the bag filter 11 need not be limited to the shapes described above and it is to be understood that other shapes are possible. For example, the bag filter 11 may have an annular, angular, regular or irregular cross-section while connections between the first, second, third and fourth sections 31, 41, 51 and 52 may also be annular or angular. Similarly, the bag filter 11 may be tapered from top to bottom or vice versa or from side to side. This tapering may be gradual or step-wise.

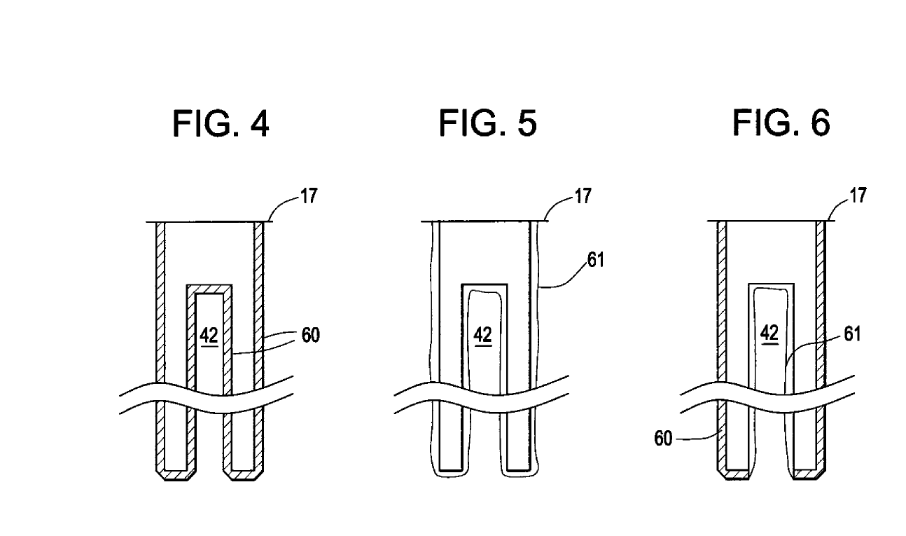

With reference to FIGS. 4, 5 and 6, the filter media 14 may be made of a fabric material and may be flat, pleated and/or may have some combination of flat and pleated sections. The pleating refers to the periodic folding of the filter media 14 around a longitudinal axis of the bag filter 11 and along the longitudinal direction. This folding is distinct from the folding of the filter media 14 in on itself in one or multiple stages 141, 142 as described above. In addition, as shown in FIG. 4, the filter media 14 may include a rigid filter element 60, which tightly conforms to the shape of the cage 20 and may incorporate the cage 20 as well. Conversely, as shown in FIG. 5, the filter media 14 may include a bag element 61 that hangs relatively loosely from the cage 20 or, as shown in FIG. 6, the filter media 14 may include a combination of the rigid filter element 60 and the bag element 61 provided in a lateral arrangement, an overlapped arrangement or a combination of lateral and overlapped arrangements.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A filter, comprising:
filter media folded into itself to have increased surface area formed of at least two filtering sections including:
an outer filtering section, and
an inner filtering section.

2. The filter according to claim 1, wherein the filter media comprises fabric.

3. The filter according to claim 1, wherein the filter media is one or more of pleated and flat.

4. The filter according to claim 1, wherein the filter media is one or more of loose and rigid.

5. The filter according to claim 1, wherein the outer and inner filtering sections are substantially tubular.

6. The filter according to claim 1, wherein the filtering sections further include lower and upper filtering sections respectively disposed at ends of the outer and inner filtering sections.

7. The filter according to claim 6, wherein filtering sections are each plural in number.

8. A filter, comprising:
a cage; and
filter media supported on the cage, the filter media including an outer filtering section, a lower filtering section connected by an outer rim thereof to a first end of the outer filtering section, an inner filtering section connected by a first end thereof to an inner rim of the lower filtering section and an upper filtering section connected by a rim thereof to a second end of the inner filtering section,
the second end of the inner filtering section opposing the first end thereof, and
the cage supporting the upper filtering section proximate to a second end of the outer filtering section, the second end opposing the first end thereof.

9. The filter according to claim 8, wherein the outer and inner filtering sections are substantially tubular.

10. The filter according to claim 9, wherein the lower and upper filtering sections are substantially annular.

11. The filter according to claim 8, wherein the filter media comprises fabric.

12. The filter according to claim 8, wherein the filter media is one or more of flat and pleated.

13. The filter according to claim 8, wherein the filter media comprises one or more of a rigid filter element and a loose filter element.

14. A cleaning system, comprising:
a housing;
a tubesheet disposed within the housing to delimit dirty and clean chambers, the tubesheet being formed to define an opening; and
a filter including a cage and filter media, the cage supporting the filter media at the opening and to be folded in on itself

15. The cleaning system according to claim 14, wherein the opening and the filter are each plural in number.

16. The cleaning system according to claim 14, wherein the opening and an external shape of the filter are similar in shape and size.

17. The cleaning system according to claim 14, wherein the filter media comprises fabric.

18. The cleaning system according to claim 14, wherein the filter media is one or more of flat and pleated.

19. The cleaning system according to claim 14, wherein the filter media comprises one or more of a rigid filter element and a loose filter element.

20. The cleaning system according to claim 14, wherein the cage supports the filter media to be folded in on itself in multiple stages.
